(19) United States
(12) Patent Application Publication
(10) Pub. No.: US 2015/0160063 A1
(43) Pub. Date: Jun. 11, 2015

(54) BEVERAGE GLASS AND BEVERAGE VESSEL FOR MIXING BEVERAGES

(71) Applicant: FERNANDO ADRIAN BERTONA, SANTA FE (AR)

(72) Inventor: FERNANDO ADRIAN BERTONA, SANTA FE (AR)

(21) Appl. No.: 14/555,734

(22) Filed: Nov. 28, 2014

(30) Foreign Application Priority Data
Dec. 6, 2013 (AR) M 20130104547

(51) Int. Cl. G01F 19/00; A47G 19/22

(52) U.S. Cl. CPC G01F 19/00; A47G 19/2227

(57) ABSTRACT

Beverage glass and a beverage vessel for mixing beverages, preferably designed to dose different amounts of wine, as well as liquors, juices, among other possible beverages to be mixed in accordance with a desired predetermined proportion choice. The bowl (1)0 has a scale measures (2) extending vertically along the bowl (1). Said scale (2) is defined by a straight line (4) line on each side of such line, a series of horizontal segments (5) that indicate the level of drink in the beverage mixture and which are associated numeric characters (6) to indicate amounts, for example, in absolute or percentage volume of the beverage mix.

### BACKGROUND OF THE INVENTION

Blending wines has always been exclusively reserved for winemakers and their sommeliers in the cellar and not for the end consumer.

A standard varietal like Malbec, Chardonnay, or others, is made from the same type of grape. Sometimes winemakers will use grapes from different plots of a vineyard or different regions for a varietal, but they are all the same type of grapes. Its possible for wineries to add other grapes to a varietal to enhance the elements and still call it a single varietal wine.

Blends are what their name suggests. They typically consist of at least 40-50 percent of one type of grape and a smaller mix of two or more other grapes. Blending is used to maximize the expression of a wine. It can enhance aromas, color, texture, body and finish, making it a more well-rounded and complex wine. If a wine doesn't have a strong scent, for example, a winemaker can add five percent of a more potent smelling grape and can experiment with different types of varietals coming from other vineyards. They could have been aged in oak barrels, fermented in various kinds of vessels or just harvested in different phases of ripeness.

The present invention allows the regular consumer to produce and taste its own blend, just for one glass, and know exactly the proportions of its creation in other to reproduce it.

The present utility model relates to a beverage glass for mixing beverages, preferably designed to dose different amounts of wine, as well as liquors, juices, among other possible beverages to be mixed in accordance with a desired predetermined proportion.

While this beverage glass can be used for mixing and drinking any kind of beverages, alcoholic or not, combined under different proportions to suit consumer taste, it has been specially prepared for mixing a variety of wines such as red and white wine, rosé, sparkling, among others, thus meeting the multiple preferences of those who appreciate and enjoy different flavors of each variety of wine according to their own characteristics. Although wine production covers a wide range of varieties of red wines such as, for example, Malbec, Cabernet, Merlot, Tempranillo, Syrah, and white wines, for example, Torrontes, Chardonnay and Sauvignon Blanc, among others, domestic experience has shown some growing trend in seeking new flavors and tastes of wines meeting very personal tastes.

Consequently, considering the need for both discerning connoisseurs of wine qualities and people in general, the aim of the beverage glass, purpose of this utility model is precisely meet the variety of tastes of those who enjoy wine in accordance with their particular preferences.

### BRIEF SUMMARY OF THE INVENTION

It is therefore a purpose of the present utility model to provide a beverage glass for mixing beverages designed to dose different amounts of wine, liquor, juices, among other possible drinks to be mixed in accordance to predetermined proportions. To this end, the bowl of the beverage glass has a measuring scale with a length extending vertically from the base of the bowl and upwardly, in accordance with the specific amount in cm3 in relation to the total volume of the beverage glass bowl.

Said scale is defined by a straight line and, on each side of such line, a sequence of horizontal segments indicates the beverage level in the mixture and to which numeric characters are associated as quantity indicators, for example, in absolute values or beverage volume percentages.

### BRIEF DESCRIPTION OF THE DRAWINGS

For clarity and understanding of the purpose of this utility model, it is illustrated in the figures that represent the invention embodiments, wherein:

FIG. 1 is an elevation view of the beverage glass.

FIG. 2 illustrates, as a single further example, a decanter that essentially fulfills the purpose of the beverage glass in FIG. 1.

### DETAILED DESCRIPTION OF THE INVENTION

Actually, it is not simple to provide a regular glass of wine of a measurement scale due to its particular shape. The present invention refers to a glass with an irregular shape, like the one used to drink wine, which includes a verified volume measurement scale printed on its surface that allows the person to use the same glass to prepare a varietal blend and to drink the prepared blend.

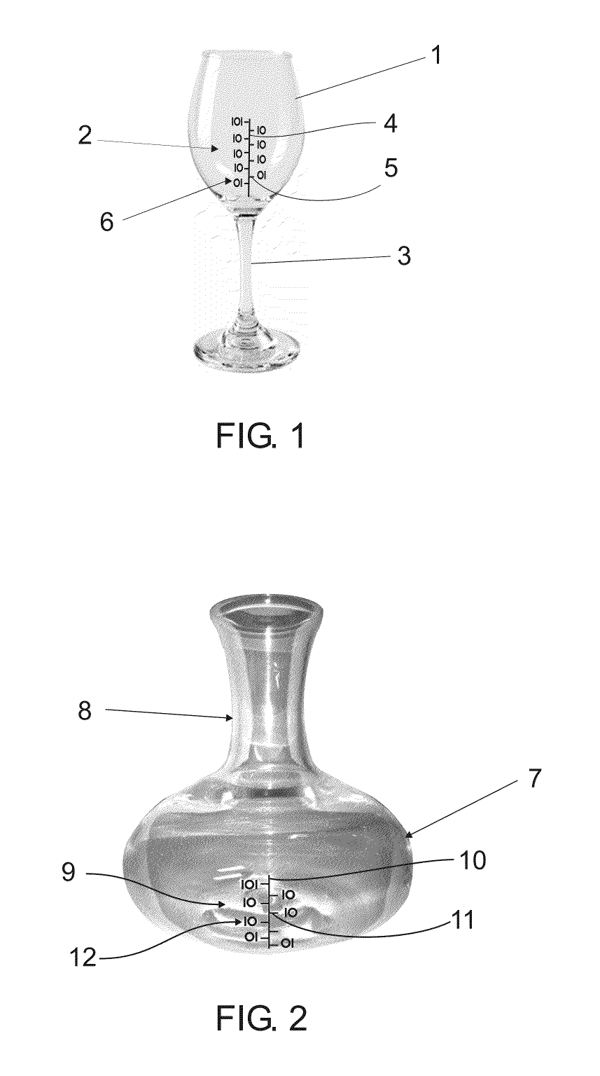

Referring first to FIG. 1, it can be seen that this beverage glass for beverage mixture includes at its bowl (1) a measurement scale (2) extending from the base thereof, namely from the lower end of the bowl (3) until a certain specified amount expressed in cm3 in relation to the total volume of the beverage glass (1). Said scale (2) is defined by a straight vertical line (4) and, on each side of such line, a series of horizontal segments (5) that function as level or proportion indicators of each beverage that is being poured into the glass to form the desired mixture.

To more accurately evaluate and control the volumes or parts of each drink poured into the glass, the scale (2) includes numeric characters (6), with a general representation, which are associated with each of said segments (5), thus, the amounts of beverages is shown, whether, for example, in absolute values or percentages by volume.

In other to prepare more quantity of a blend, always in the range of volumes for personal consuming, a decanter is shown in FIG. 2. A decanter is a vessel that is used to hold the decantation of a liquid (such as wine) which may contain sediment. Decanters are normally used as serving vessels for wine. This decanter, that may hold up to two litres of liquid, and includes a verified volume measurement printed on its surface.

In FIG. 2, a bottle also designed to mix drinks, consist of a main body (7), and under its aperture at the top (8), includes a measuring scale (9) extending vertically from its bottom base. The scale (9), in analogy to the beverage glass of FIG. 1, is defined by a straight vertical line (10), and, on each side of such line, a series of horizontal segments (11) that function as level or proportion indicators of each beverage that is being poured into the bottle (7) to form the desired mixture. Similarly, the scale (9) includes numeric characters (12), generically represented, and associated with each of said segments (11) to indicate the amounts of added beverage, whether, for example, in absolute volume or percentages.

1. A beverage glass for mixing beverages, designed to dose different amounts of wine, in accordance with a desired predetermined proportion choice, comprising a glass formed by a foot, a stem and a bowl, where the bowl is printed with a measuring scale defined by a line extending vertically from the base of the bowl projecting on either side of said line a corresponding series of horizontal segments as levels or proportion indicators, and numeric characters included in said scale as quantities indicators, in absolute or percentage volume values, associated to each of said segments.

2. A beverage glass vessel for mixing beverages, designed to dose different amounts of wine, in accordance with a desired predetermined proportion choice, comprising a vessel formed by a bowl and a tall neck, where the bowl is printed with a measuring scale defined by a line extending vertically from the base of the bowl projecting on either side of said line a corresponding series of horizontal segments as levels or proportion indicators, and numeric characters included in said scale as quantities indicators in absolute or percentage volume values, associated to each of said segments.
